(19) United States
(12) Patent Application Publication
(10) Pub. No.: US 2010/0041366 A1
(43) Pub. Date: Feb. 18, 2010

(54) METHOD AND APPARATUS FOR CONTROL OF SERVICE USAGE IN A COMMUNICATIONS SYSTEM

(76) Inventor: Peter Zackrisson, Lyckeby (SE)

Correspondence Address: ERICSSON INC., 6300 LEGACY DRIVE, M/S EVR 1-C-11, PLANO, TX, 75024, US

(21) Appl. No.: 12/514,439

(22) PCT Filed: Nov. 12, 2007
(86) PCT No.: PCT/EP2007/009759

§ 371 Date: May 11, 2009

(30) Foreign Application Priority Data
Nov. 10, 2006 (SE) 0602416-0

(51) Int. Cl. H04M 11/00; H04W 4/00

(52) U.S. Cl. 455/406; 455/466

(57) ABSTRACT

A method and apparatus for control of service usage in a communications system, wherein a charging client receives a service request from a user initiating a charging transaction. In response to the service request checking a free of charge indicator in the charging client, and if the free of charge indicator is confirmative for the service request the charging client granting the service request to the user.

### TECHNICAL FIELD

The present invention relates to signaling in a communications network and more particularly to a method and apparatus for control of service usage in a communications system for charging signaling capacity savings.

### BACKGROUND

Some communications system operators want to sell unlimited access, or access with very liberate limitations, to a service for a specific period, for example one day and charging the subscriber a specific amount of money. For example by paying 1∈ the subscriber can send as many SMS they like for one day. The subscribers which have not paid this 1∈ extra will be charged for the SMS as normal.

U.S. Pat. No. 5,995,822 discloses a real-time charging system, wherein each chargeable event needs to be send to the charging system in order to know if it is currently free of charge or not. This is needed since a service can cost money for some subscribers and be currently free of charge for others.

Many different protocols can be used to inform the charging system of the chargeable event, for example Customized Application for Mobile network Enhanced Logic CAMEL, Capability Set 1 CS1, and Diameter.

Offers like that described above can lead to a substantial increase of signaling. When users have paid for a more or less unlimited service usage for a limited time period they tend to use this more frequently. A problem with prior art solutions are that even when the chargeable event is free of charge it still leads to signaling towards the charging system. IN based solutions like CS1 an CAMEL is known to be capacity demanding both on the client side, like for example an MSC, and on the charging system.

### SUMMARY

It is an object of the present invention to provide an improved apparatus and method for control of service usage in a communications system saving charging signaling capacity avoiding the above mentioned drawbacks of increased signaling for charging of services with more or less unlimited access during a specific time period.

According to some embodiments of the invention, there is provided a method for control of service usage in a communications system comprising the steps of: receiving in a charging client a service request from a user initiating a charging transaction; in response to the service request checking a free of charge indicator in the charging client; and if the free of charge indicator is confirmative for the service request the charging client granting the service request to the user.

A more specific object of the invention is to provide a programmable apparatus for control of service usage in a communications system. The programmable apparatus is configured to: receive a service request from a user initiating a charging transaction; in response to the service request checking a free of charge indicator; and if the free of charge indicator is confirmative for the service request granting the service request to the user.

According to some embodiments of the invention, there is provided a method for control of service usage in a communications system comprising the steps of: receiving in a charging system an inquiry to check whether the service is allowed for a requesting user and/or whether enough money is available for the requested service; in response to the received inquiry, checking if the service is allowed and/or if there are enough money available to perform the requested service; and sending an answer message whether the service is allowed and/or there is enough money available for the requested service.

Further embodiments are defined by the dependent claims.

An advantage of the invention is that as charging is only invoked for example once a day (or even less if dates or number of days is used) capacity can greatly be increased. For an example if 100000 people pay for having SMS free of charge for the rest of the day and then sends 10 SMS each. 900000 charging invocations can be saved in one day. If these 10 SMS is sent during 8 hours this corresponds to a saving of roughly 30 invocations per second.

It is still possible for the charging client to generate off-line Call Detail Records CDRs in order to be able to produce statistics or in order to fulfill legal regulations.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

In order to explain the invention in more detail and the advantages and features of the invention, a preferred embodiment will be described in detail below, reference being made to the accompanying drawings, in which

FIG. 1 is a block diagram of a communications system.

FIG. 2 is a signaling diagram illustrating exchange of signals in a communications system according to some embodiments of the method of the invention.

FIG. 3 a signaling diagram illustrating exchange of signals in a communications system according to some embodiments of the method of the invention.

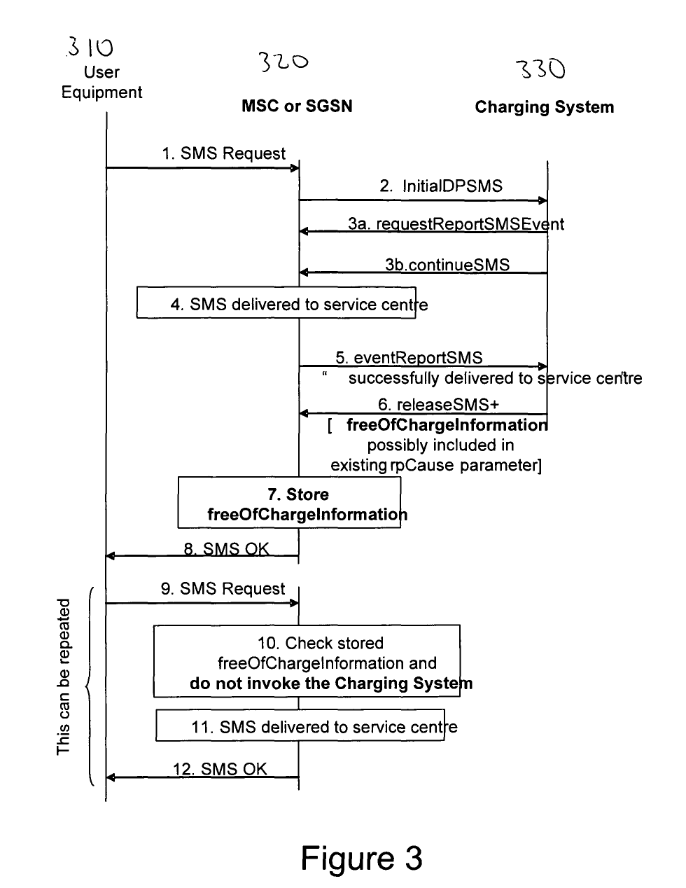

### DETAILED DESCRIPTION

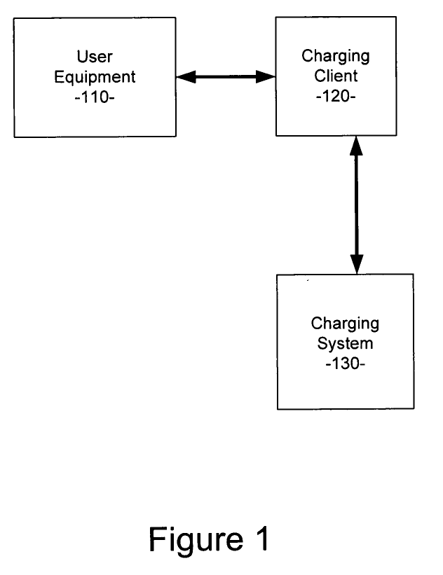

FIG. 1 is a block diagram of a communications system including, but is not limited to, a user equipment 110, a charging client 120, and a charging system 130 for charging service usage.

According to some embodiments of the invention the charging client may be informed that a service for a specific subscriber is free of charge during a given period (for example for a couple of days). This may be done embedded in the normal traffic flow between the charging client 120 and the charging system 130. One way of informing the charging client is to send this information back on the first chargeable event for this period.

The user equipment 110 may be a mobile station. The term mobile station as used herein refers to any portable communication device having the ability to connect wirelessly to a communication network. The term mobile station comprises, without limitation, mobile telephones, pagers, personal digital assistants, and laptop or handheld computers.

The charging client 120, like for example a Mobile Switching Center MSC or Serving GPRS Support Node SGSN, needs to store this information and can for the next chargeable event check if this service is free of charge or not. If it is free of charge the charging system needs not to be triggered for consecutive events.

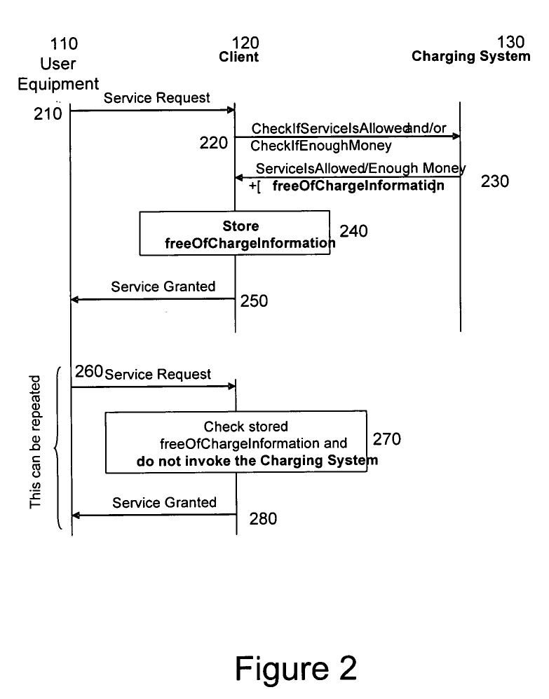

Some embodiments of the method for control of service usage in a communications system for charging signaling capacity savings in a communications system is described with reference to the signaling flow of FIG. 2.

The user equipment 110 requests for a service, for example an SMS, to the charging client 120 in step 210. The charging client 120 sends an inquiry to the charging system 130 to check whether the service is allowed for a requesting user and/or whether enough money is available for the requested service in step 220. In response to the received inquiry the charging system 130 checks if the service is allowed and/or if there are enough money available to perform the requested service and send an answer message back to the charging client in step 230. Moreover, the charging system 130 also checks if there is free of charge information for the requesting user in the charging system. If there is free of charge information for the requesting user, the charging system 130 includes free of charge information (freeOfChargeInformation) in the answer message to the charging client in step 230. The received freeOfChargeInformation is stored in the charging client in step 240.

The freeOfChargeInformation consists of either

a free of charge today flag

number of free days

date/time where service is to be checked again

If the charging client were informed of a “free today” flag the charging client needs to reset this flag for example every night.

If the service is determined to be allowed and/or enough money is available, a service granted message is sent to the user equipment in step 250.

The following service requests, covered by the freeOfChargeInformation previously received from the charging system 130, may then be handled by the charging client 120 without involvement of the charging system 130. This is illustrated by the steps 260, 270, and 280 in FIG. 2.

The user equipment 110 requests for a service, for example an SMS, initiating a charging transaction to the charging client 120 in step 260. In response to the service request the charging client checks the freeOfChargeInformation in step 270. If the freeOfChargeInformation is confirmative for the service request the charging client granting the service request in step 280 to the user equipment from which the service was requested and the service may be performed.

The steps 260-280 may then be repeated one or more times within the limit of the freeOfChargeInformation.

With this solution the capacity can be greatly increased as each consecutive free of charge event does not need to invoke charging, which mean that capacity is gained in both the charging client and in the charging system.

It is possible to include some kind of “misuse”-control in the client. For example the operator might despite saying “unlimited” service include some limits in the small print. For example this might mean there is a limit of 1000 SMS for a period. This can be implemented on the client side with help of a counter. When the counter has reached its limit, service might be rejected.

FIG. 2 describes a method according to another embodiment of the invention. However the invention is not limited to this example. Information that a service is free of charge can be received as a result of the first chargeable event for this subscriber from this client every day. It is also possible to inform that the service is free of charge up to a specific date in the same way.

It may also be possible to provide the charging client with this information “on the side” and not as part of the traffic flow.

This mechanism can also be used for other services and not only for charging. Instead of scanning all subscribers to reset the “free of charge flags” there are other possible mechanisms to make sure only one event per day is sent, for example by storing an end-date which is compared with the current date.

The following example is based on CAMEL, described in 3GPP TS 22.078, 23.078 and 29.078.

Flow of events:

A subscriber sends the first SMS for a day:

An SMS is received in the MSC/VLR 320, which acts like a charging client in step 1. An initial DPSMS is sent to the charging system 330 in step 2. The charging system 330 detects that that the SMS is free of charge this day and the charging system normally responds with a requestReportSMSEvent in step 3a and a continueSMS (connectSMS could also be used) in step 3b.

The MSC/VLR 330 sends the SMS further to the SMS-centre in step 4, which responds with successful if the SMS is successfully received. The MSC/VLR reports a successful delivery by using eventReportSMS to the charging system 330 in step 5.

The charging system would now have deducted the account if this was a charged SMS. However, in response to the received eventReportSMS the charging system 330 will now, as the SMS was free of charge, send back a new release cause (RPCause) in step 6 including free of charge information (freeOfChargeInformation) in the releaseSMS message which is used to end the charging session for the SMS. Several new release causes can be used to express the number of days the SMS is free of charge. The MSC/VLR 320 will use this new release cause and store a flag on the subscriber in the VLR in step 7. The handset is informed that the SMS was delivered OK in step 8.

A subscriber sends another SMS the same day:

An SMS is received in the MSC/VLR which acts like a charging client in step 9. The MSC/VLR 320 detects that the “SMS free of charge” flag is set in step 10 and will suppress CAMEL charging for SMS. Hence, the charging system will not be invoked. In step 11 the MSC/VLR sends the SMS further to the SMS-centre which responds with successful if the SMS is successfully received. The handset is informed that the SMS was delivered OK in step 12.

If free of charge flag is used The steps 9-12 may then be repeated one or more times within the limit of the freeOfChargeInformation.

The MSC/VLR 320 may scan all subscribers and reset the free of charge flag. However, when using dates/time this, possibly capacity demanding, scan of subscribers can be eliminated.

When roaming into new MSC/VLR the freeOfChargeInformation is reset when roaming into a new MSC/VLR. This means that a new invocation of the charging system will be needed.

Using the RPCause in the way described above is outside the scope of the CAMEL specification. This means that the charging system will need to be aware of which MSC/VLR that can handle this extensions of RPCause:s. In this specific case it is recommended that the rpCause contains information about the number of free days.

In the example above a new invocation will be needed for the fist chargeable event each day.

According to some other embodiments the signaling may be decreased even more. The RPCause may include the number of days the SMS is free of charge. For example the unused values 51 to 64 can be used to indicate that 1 to 14 days are free.

Instead of the MSC/VLR storing the number of free days (which has to be decreased every night) the MSC/VLR may then calculate the date when the service is to end based on the current date. When this date is reached a new invocation is set to the charging system to see if the SMS is still free of charge or should be charged item by item.

It is possible to use the same mechanism to decrease signaling for voting. For example if only one vote per phone is allowed, IN can be suppressed for every call but the first one. This can be used to prevent that one person votes a large number of times.

Although the embodiments of the MSC/VLR described with reference to the drawings comprise a computer apparatus and processes performed in the computer apparatus, the invention also extends to programs on or in a carrier, adapted for putting the invention into practice when the computer program is executed. The program may be in the form of source code, object code a code suitable for use in the implementation of the method according to the invention. The carrier can be any entity or device capable of carrying the program. For example the carrier may be a record medium, computer memory, read-only memory or an electrical carrier signal.

1. A method for control of service usage in a communications system comprising the steps of:
receiving in a charging client a service request from a user initiating a charging transaction, in response to the service request checking a free of charge indicator in the charging client, and
if the free of charge indicator is confirmative for the service request the charging client granting the service request to the user.

2. A method according to claim 1, comprising, before the step of receiving in the charging client a service request, the further steps of:
receiving in the charging client from a charging system a free of charge indicator; and
storing said free of charge indicator.

3. A method according to claim 2, wherein the free of charge indicator is received in the charging client in response to a successful first chargeable event.

4. A method according to claim 1, wherein the number of granted service requests is counted and the step of checking the free of charge indicator in the charging client comprises the further step of checking if the number of granted service requests has reached a limit, and if the limit is reached the service request is rejected.

5. A method according to claim 1, wherein said signaling is a CAMEL signaling.

6. A method according to claim 2, wherein the free of charge indicator is received as part of the traffic flow.

7. A method according to claim 2, wherein the free of charge indicator is received as a separate message.

8. A method according to claim 2, wherein the requested service is an SMS and that the free of charge indicator is received as a new release cause including free of charge information in a release SMS message which is used to end the charging session for the SMS.

9. A method according to claim 8, wherein several new release causes are used to express the time the SMS service is free of charge.

10. A method according to claim 2, wherein the requested service is a vote.

11. A method according to claim 1, wherein the free of charge indicator comprises a free of charge today flag, or a number of free days, or date/time where service is to be checked again.

12. An apparatus for control of service usage in a communications system configured to:
receive a service request from a user initiating a charging transaction, in response to the service request checking a free of charge indicator, and if the free of charge indicator is confirmative for the service request granting the service request to the user.

13. The apparatus according to claim 12, where said apparatus comprises a programmable apparatus and is configured to:
receive a free of charge indicator from a charging system; and storing said free of charge indicator.

14. The method of claim 6 where said method is performed by a programmable apparatus, wherein said signaling is a CAMEL signaling.
